(19) United States
(12) Patent Application Publication
(10) Pub. No.: US 2013/0224368 A1
(43) Pub. Date: Aug. 29, 2013

(54) MUSHROOM FOOD ARTICLE AND METHOD OF MAKING THE SAME

(71) Applicant: Xianmin GUAN, Fremont, CA (US)

(72) Inventor: Xianmin GUAN, Fremont, CA (US)

(21) Appl. No.: 13/862,192

(22) Filed: Apr. 12, 2013

Related U.S. Application Data
(63) Continuation-in-part of application No. 12/717,832, filed on Mar. 4, 2010.
Application No. 12/717,832 is a continuation-in-part of application No. 12/717,835, filed on Mar. 4, 2010.

(51) Int. Cl. A23L 1/314

(52) U.S. Cl. CPC A23L 1/31427
USPC 426/615; 426/646; 426/643; 426/644; 426/645; 426/513

(57) ABSTRACT

The present invention provides a food article and methods and systems of making the same.

### CROSS-REFERENCE TO RELATED APPLICATIONS

This is a continuation-in-part application of U.S. application No. 12/717,832 and 12/717,835, filed on Mar. 4, 2010. The teachings in these applications are incorporated herein by reference in their entirety.

### FIELD OF THE INVENTION

The present invention relates to food articles and method and apparatus of making the same.

### BACKGROUND OF THE INVENTION

Fast food articles are important part of the life of the U.S. public. For example, hundreds of millions hamburger patties are consumed daily in the U.S. alone. A hamburger (or burger for short) is a sandwich consisting of a cooked patty of ground meat, (usually beef, but occasionally pork, turkey, or a combination of meats) placed between two wheat buns. Hamburgers are often served with lettuce, tomato, onion, pickles, or cheese and condiments such as mustard, mayonnaise, and ketchup; these condiments or excess material are optional for the consumer. The hamburger has attained widespread popularity and is proliferated worldwide in chains such as McDonald's, Burger King, and Wendy's.

Problems associated with fast food articles are well documented. Take hamburgers as an example. The meat patty is generally greasy and has a high cholesterol level. Purportedly, the fresh produce part of the hamburger is to provide other necessary nutrients, e.g., fiber, vitamins, to make the hamburger to be of nutritiously more balanced. Unfortunately, fresh produce ingredients have a taste and texture quite different from the meat stuff (hamburger patty). Many consumers of hamburgers such as school age children only eat the bun and patty parts of the hamburger. As the result, the benefit of having fresh produce ingredients in a hamburger is often unfulfilled.

Therefore, there is a need for a fast food article that provides more balanced nutrients.

There is a further need for a fast food article that provides necessary nutrients other than the meat stuff having a taste and texture more compatible with the meat stuff in the fast food article.

The embodiments of the present invention address the above-identified needs and issues.

### SUMMARY OF THE INVENTION

In one aspect of the present invention, the present invention provides a food article. The food article comprises ground meat and mushroom ingredients. The ground mushroom ingredient has a taste texture compatible with the ground meat ingredient. In some embodiments, the food article has a meat to mushroom weight ratio ranging from about 1:99 to about 99:1. For example, the food article can have a meat to mushroom weight ratio of any of the following ranges:
from about 1:99 to about 90:10, from about 1:99 to about 80:20, from about 1:99 to about 70:30, from about 1:99 to about 60:40, from about 1:99 to about 50:50, from about 1:99 to about 40:60, from about 1:99 to about 30:70, from about 1:99 to about 20:80, from about 1:99 to about 10:90;
from about 5:95 to about 99:1, from about 5:95 to about 90:10, from about 5:95 to about 80:20, from about 5:95 to about 70:30, from about 5:95 to about 60:40, from about 5:95 to about 50:50, from about 5:95 to about 40:60, from about 5:95 to about 30:70, from about 5:95 to about 20:80, from about 5:95 to about 10:90;
from about 10:90 to about 99:1, from about 10:90 to about 90:10,
from about 10:90 to about 80:20, from about 10:90 to about 70:30,
from about 10:90 to about 60:40, from about 10:90 to about 50:50,
from about 10:90 to about 40:60, from about 10:90 to about 30:70,
from about 10:90 to about 20:80;
from about 20:80 to about 99:1, from about 20:80 to about 90:10,
from about 20:80 to about 80:20, from about 20:80 to about 70:30,
from about 20:80 to about 60:40, from about 20:80 to about 50:50,
from about 20:80 to about 40:60, from about 20:80 to about 30:70;
from about 30:70 to about 99:1, from about 30:70 to about 90:10,
from about 30:70 to about 80:20, from about 30:70 to about 70:30,
from about 30:70 to about 60:40, from about 30:70 to about 50:50,
from about 30:70 to about 40:60,
from about 40:60 to about 99:1, from about 40:60 to about 90:10,
from about 40:60 to about 80:20, from about 40:60 to about 70:30,
from about 40:60 to about 60:40, from about 40:60 to about 50:50;
from about 50:50 to about 99:1, from about 50:50 to about 90:10,
from about 50:50 to about 80:20, from about 50:50 to about 70:30,
from about 50:50 to about 60:40;
from about 60:40 to about 99:1, from about 60:40 to about 90:10,
from about 60:40 to about 80:20, from about 60:40 to about 70:30;
from about 70:30 to about 99:1, from about 70:30 to about 90:10,
from about 70:30 to about 80:20;
from about 80:20 to about 99:1, or from about 80:20 to about 90:10.

The meat ingredient can be any edible animal meat or fish meat. For example, common edible animal meat or fish meat include, e.g., beef, pork, chicken, turnkey, sheep meat (e.g., lamb), goat meat, tuna, salmon, donkey meat, horse meat, or meat of animal edible in a ethnic culture.

The mushroom ingredient can include any edible mushroom or a mixture of edible mushrooms. Edible mushrooms include wild mushrooms and/or cultivated mushrooms. The mushroom(s) can be uncooked mushroom or cooked mushroom, which are described in more detail below. In some embodiments, the mushroom ingredients include ground fresh mushroom, cooked mushroom, or a mixture thereof. Note, mushrooms have different flavor and nutrients, e.g., soluble fibers, vitamin, and antioxidants. Varying the composition of the mushroom mixture can impart the food article of invention different flavor and nutrients, thereby providing a way to modulate the nutrient content of the food article of invention.

In some embodiments, optionally with one or any combination of features of the various embodiments above, the meat ingredient can be artificial meat.

In some embodiments, optionally with one or any combination of features of the various embodiments above, the meat ingredient specifically excludes artificial meat.

In some embodiments, optionally with one or any combination of features of the various embodiments above, the food article can include other food ingredients, e.g., bean stuff, tofu, flour, flour gluten, oatmeal, dry or fresh vegetable ingredients, potato, tomato, etc.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

As compared to a food article without mushroom, the food article disclosed herein has a lowered or reduced cholesterol level, fat or grease content, or calories. The per serving cholesterol content of a food article of invention can be about 90% or below, about 80% or below, about 70% or below, about 60% or below, about 50% or below, about 40% or below, about 30% or below, about 20% or below, or about 10% or below of the per serving cholesterol content of a food article formed from all meat(s) or substantially all meat(s). The per serving grease or fat content of a food article of invention can be about 90% or below, about 80% or below, about 70% or below, about 60% or below, about 50% or below, about 40% or below, about 30% or below, about 20% or below, or about 10% or below of the per serving grease or fat content of a food article formed from all meat(s) or substantially all meat(s). The per serving calories of a food article of invention can be about 90% or below, about 80% or below, about 70% or below, about 60% or below, about 50% or below, about 40% or below, about 30% or below, about 20% or below, or about 10% or below of the per serving calories of a food article formed from all meat(s) or substantially all meat(s).

Additional advantages of the food article disclosed herein is the nutrients from the mushroom ingredient, the nutritional fact per serving of an exemplary mushroom serving is provided below.

The food article described above can be formed into any acceptable food article, such as hamburger patty, etc., and can be included in a food article in any form, e.g., a hamburger.

A food article disclosed herein can be formed generally by a method comprising the following steps:

providing a frozen mushroom ingredient,

providing a frozen meat ingredient,

grinding the frozen mushroom ingredient to generate a ground mushroom ingredient,

grinding the frozen meat ingredient to generate a ground meat ingredient, and

forming the food article.

In some embodiments, the forming step can include forming a mixture of the ground mushroom ingredient and the ground meat ingredient and pressing the mixture to form the food article.

In another aspect, the present invention provides a food article, comprising a homogenous or substantially homogenous mixture of a ground meat ingredient, a ground mushroom ingredient, and an optional exogenous antioxidant,

wherein the ground mushroom ingredient comprises granules of a size from about 1 mm to about 55 mm measured at 0° C. such that, in the homogenous or substantially homogenous mixture, has texture and taste similar to those of the ground meat ingredient.

In some embodiments of the present invention, optionally in combination with any or all of the various embodiments disclosed herein, the food has a meat to mushroom weight ratio ranging from about 1:99 to about 99:1.

In some embodiments of the present invention, optionally in combination with any or all of the various embodiments disclosed herein, the food article has a meat to mushroom weight ratio ranging from about 10:90 to about 90:10, from about 20:80 to about 80:20, from about 30:70 to about 70:30, from about 40:60 to about 60:40 or about 50:50.

In some embodiments of the present invention, optionally in combination with any or all of the various embodiments disclosed herein, the meat ingredient comprises beef, pork, fish, chicken, turkey, lamb, goat, or a mixture of these.

In some embodiments of the present invention, optionally in combination with any or all of the various embodiments disclosed herein, the food article is a patty. An example of such patty is hamburger patty.

In some embodiments of the present invention, optionally in combination with any or all of the various embodiments disclosed herein, the food article is cooked or uncooked.

In some embodiments of the present invention, optionally in combination with any or all of the various embodiments disclosed herein, the food article has a reduced cholesterol level as compared with a food article comprising a meat ingredient with no mushroom ingredient.

In some embodiments of the present invention, optionally in combination with any or all of the various embodiments disclosed herein, the food article has reduced calories per serving of a given weight as compared with a food article comprising a meat ingredient with no mushroom ingredient.

In some embodiments, a food article disclosed herein can be formed by a method comprising the following steps:

providing a frozen mushroom ingredient,

providing a frozen meat ingredient,

forming a mixture of the frozen mushroom ingredient and the frozen meat ingredient;

grinding the mixture of the frozen mushroom ingredient and the frozen meat ingredient, and

forming the food article.

In some embodiments, a food article disclosed herein can be formed by a method comprising the following steps:

providing a mixture comprising a mushroom ingredient and a meat ingredient,

freezing the mixture comprising a mushroom ingredient and a meat ingredient to generate a frozen mixture comprising a mushroom ingredient and a meat ingredient;

grinding the frozen mixture comprising a mushroom ingredient and a meat ingredient; and

forming the food article.

Various embodiments of the meat ingredient, the mushroom ingredient, and the ratios thereof are all discussed above or below, which are incorporated in their entirety herein.

In another aspect, the present invention provide a method for preparing a food article, the method comprising:

providing a homogenous or substantially homogenous mixture comprising a ground frozen mushroom ingredient, a ground frozen meat ingredient, and an optional exogenous antioxidant, and

forming the food article,

wherein the ground mushroom ingredient comprises granules of a size from about 1 mm to about 55 mm measured at 0° C. such that, in the homogenous or substantially homogenous mixture, has texture and taste similar to those of the ground meat ingredient, and

In some embodiments of the invention method, optionally in combination with any or all the various embodiments disclosed herein, forming the food article comprises pressing the homogenous or substantially homogenous mixture to form the food article.

In some embodiments of the invention method, optionally in combination with any or all the various embodiments disclosed herein, the frozen mushroom ingredient in method (i) and method (ii) is provided by freezing a cooked mushroom ingredient and the mushroom ingredient in method (iii) is a cooked mushroom ingredient.

In some embodiments of the invention method, optionally in combination with any or all the various embodiments disclosed herein, the cooked mushroom ingredient is provided by heating the mushroom ingredient using a heating pan or by boiling water, hot oil, infrared light, magnetic heating, microwave, hot air, or steam.

In some embodiments of the invention method, optionally in combination with any or all the various embodiments disclosed herein, the food article has a meat to mushroom weight ratio ranging from about 1:99 to about 99:1.

In some embodiments of the invention method, optionally in combination with any or all the various embodiments disclosed herein, the food article has a reduced cholesterol level, reduced calories, or a reduced level of glycerides.

In some embodiments of the invention method, optionally in combination with any or all the various embodiments disclosed herein, the food article is a hamburger patty.

In some embodiments of the invention method, optionally in combination with any or all the various embodiments disclosed herein, the meat ingredient is selected from the group consisting of beef, pork, fish, chicken, turkey, lamb, goat, and a combination thereof.

### BRIEF DESCRIPTION OF THE DRAWING

FIG. 1 illustrates an embodiment of the present invention.

### DETAILED DESCRIPTION

In one aspect of the present invention, the present invention provides a food article. The food article comprises ground meat and mushroom ingredients. The ground mushroom ingredient has a taste texture compatible with the ground meat ingredient. In some embodiments, the food article has a meat to mushroom weight ratio ranging from about 1:99 to about 99:1. For example, the food article can have a meat to mushroom weight ratio of any of the following ranges:
from about 1:99 to about 90:10, from about 1:99 to about 80:20, from about 1:99 to about 70:30, from about 1:99 to about 60:40, from about 1:99 to about 50:50, from about 1:99 to about 40:60, from about 1:99 to about 30:70, from about 1:99 to about 20:80, from about 1:99 to about 10:90;
from about 5:95 to about 99:1, from about 5:95 to about 90:10, from about 5:95 to about 80:20, from about 5:95 to about 70:30, from about 5:95 to about 60:40, from about 5:95 to about 50:50, from about 5:95 to about 40:60, from about 5:95 to about 30:70, from about 5:95 to about 20:80, from about 5:95 to about 10:90;
from about 10:90 to about 99:1, from about 10:90 to about 90:10,
from about 10:90 to about 80:20, from about 10:90 to about 70:30,
from about 10:90 to about 60:40, from about 10:90 to about 50:50,
from about 10:90 to about 40:60, from about 10:90 to about 30:70,
from about 10:90 to about 20:80;
from about 20:80 to about 99:1, from about 20:80 to about 90:10,
from about 20:80 to about 80:20, from about 20:80 to about 70:30,
from about 20:80 to about 60:40, from about 20:80 to about 50:50,
from about 20:80 to about 40:60, from about 20:80 to about 30:70;
from about 30:70 to about 99:1, from about 30:70 to about 90:10,
from about 30:70 to about 80:20, from about 30:70 to about 70:30,
from about 30:70 to about 60:40, from about 30:70 to about 50:50,
from about 30:70 to about 40:60,
from about 40:60 to about 99:1, from about 40:60 to about 90:10,
from about 40:60 to about 80:20, from about 40:60 to about 70:30,
from about 40:60 to about 60:40, from about 40:60 to about 50:50;
from about 50:50 to about 99:1, from about 50:50 to about 90:10,
from about 50:50 to about 80:20, from about 50:50 to about 70:30,
from about 50:50 to about 60:40;
from about 60:40 to about 99:1, from about 60:40 to about 90:10,
from about 60:40 to about 80:20, from about 60:40 to about 70:30;
from about 70:30 to about 99:1, from about 70:30 to about 90:10,
from about 70:30 to about 80:20;
from about 80:20 to about 99:1, or from about 80:20 to about 90:10.

The meat ingredient can be any edible animal meat or fish meat. For example, common edible animal meat or fish meat include, e.g., beef, pork, chicken, turnkey, sheep meat (e.g., lamb), goat meat, tuna, salmon, donkey meat, horse meat, or meat of animal edible in a ethnic culture.

The mushroom ingredient can include any edible mushroom or a mixture of edible mushrooms. Edible mushrooms include wild mushrooms and/or cultivated mushrooms. The mushroom(s) can be uncooked mushroom or cooked mushroom, which are described in more detail below. In some embodiments, the mushroom ingredients include ground fresh mushroom, cooked mushroom, or a mixture thereof. Note, mushrooms have different flavor and nutrients, e.g., soluble fibers, vitamin, and antioxidants. Varying the composition of the mushroom mixture can impart the food article of invention different flavor and nutrients, thereby providing a way to modulate the nutrient content of the food article of invention.

In some embodiments, optionally with one or any combination of features of the various embodiments above, the meat ingredient can be artificial meat.

In some embodiments, optionally with one or any combination of features of the various embodiments above, the meat ingredient specifically excludes artificial meat.

In some embodiments, optionally with one or any combination of features of the various embodiments above, the food article can include other food ingredients, e.g., bean stuff, tofu, flour, flour gluten, oatmeal, dry or fresh vegetable ingredients, potato, tomato, etc.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

As compared to a food article without mushroom, the food article disclosed herein has a lowered or reduced cholesterol level, fat or grease content, or calories. The per serving cholesterol content of a food article of invention can be about 90% or below, about 80% or below, about 70% or below, about 60% or below, about 50% or below, about 40% or below, about 30% or below, about 20% or below, or about 10% or below of the per serving cholesterol content of a food article formed from all meat(s) or substantially all meat(s). The per serving grease or fat content of a food article of invention can be about 90% or below, about 80% or below, about 70% or below, about 60% or below, about 50% or below, about 40% or below, about 30% or below, about 20% or below, or about 10% or below of the per serving grease or fat content of a food article formed from all meat(s) or substantially all meat(s). The per serving calories of a food article of invention can be about 90% or below, about 80% or below, about 70% or below, about 60% or below, about 50% or below, about 40% or below, about 30% or below, about 20% or below, or about 10% or below of the per serving calories of a food article formed from all meat(s) or substantially all meat(s).

Additional advantages of the food article disclosed herein is the nutrients from the mushroom ingredient, the nutritional fact per serving of an exemplary mushroom serving is provided below.

The food article described above can be formed into any acceptable food article, such as hamburger patty, etc., and can be included in a food article in any form, e.g., a hamburger.

A food article disclosed herein can be formed generally by a method comprising the following steps:

providing a frozen mushroom ingredient,

providing a frozen meat ingredient,

grinding the frozen mushroom ingredient to generate a ground mushroom ingredient,

grinding the frozen meat ingredient to generate a ground meat ingredient, and

forming the food article.

In some embodiments, the forming step can include forming a mixture of the ground mushroom ingredient and the ground meat ingredient and pressing the mixture to form the food article.

In another aspect, the present invention provides a food article, comprising a homogenous or substantially homogenous mixture of a ground meat ingredient, a ground mushroom ingredient, and an optional exogenous antioxidant,

wherein the ground mushroom ingredient comprises granules of a size from about 1 mm to about 55 mm measured at 0° C. such that, in the homogenous or substantially homogenous mixture, has texture and taste similar to those of the ground meat ingredient.

In some embodiments of the present invention, optionally in combination with any or all of the various embodiments disclosed herein, the food has a meat to mushroom weight ratio ranging from about 1:99 to about 99:1.

In some embodiments of the present invention, optionally in combination with any or all of the various embodiments disclosed herein, the food article has a meat to mushroom weight ratio ranging from about 10:90 to about 90:10, from about 20:80 to about 80:20, from about 30:70 to about 70:30, from about 40:60 to about 60:40 or about 50:50.

In some embodiments of the present invention, optionally in combination with any or all of the various embodiments disclosed herein, the meat ingredient comprises beef, pork, fish, chicken, turkey, lamb, goat, or a mixture of these.

In some embodiments of the present invention, optionally in combination with any or all of the various embodiments disclosed herein, the food article is a patty. An example of such patty is hamburger patty.

In some embodiments of the present invention, optionally in combination with any or all of the various embodiments disclosed herein, the food article is cooked or uncooked.

In some embodiments of the present invention, optionally in combination with any or all of the various embodiments disclosed herein, the food article has a reduced cholesterol level as compared with a food article comprising a meat ingredient with no mushroom ingredient.

In some embodiments of the present invention, optionally in combination with any or all of the various embodiments disclosed herein, the food article has reduced calories per serving of a given weight as compared with a food article comprising a meat ingredient with no mushroom ingredient.

In some embodiments, a food article disclosed herein can be formed by a method comprising the following steps:

providing a frozen mushroom ingredient,

providing a frozen meat ingredient,

forming a mixture of the frozen mushroom ingredient and the frozen meat ingredient;

grinding the mixture of the frozen mushroom ingredient and the frozen meat ingredient, and forming the food article.

In some embodiments, a food article disclosed herein can be formed by a method comprising the following steps:

providing a mixture comprising a mushroom ingredient and a meat ingredient,

freezing the mixture comprising a mushroom ingredient and a meat ingredient to generate a frozen mixture comprising a mushroom ingredient and a meat ingredient;

grinding the frozen mixture comprising a mushroom ingredient and a meat ingredient; and

forming the food article.

Various embodiments of the meat ingredient, the mushroom ingredient, and the ratios thereof are all discussed above, which are incorporated in their entirety herein.

In another aspect, the present invention provide a method for preparing a food article, the method comprising:

providing a homogenous or substantially homogenous mixture comprising a ground frozen mushroom ingredient, a ground frozen meat ingredient, and an optional exogenous antioxidant, and

forming the food article,

wherein the ground mushroom ingredient comprises granules of a size from about 1 mm to about 55 mm measured at 0° C. such that, in the homogenous or substantially homogenous mixture, has texture and taste similar to those of the ground meat ingredient, and

In some embodiments of the invention method, optionally in combination with any or all the various embodiments disclosed herein, forming the food article comprises pressing the homogenous or substantially homogenous mixture to form the food article.

In some embodiments of the invention method, optionally in combination with any or all the various embodiments disclosed herein, the frozen mushroom ingredient in method (i) and method (ii) is provided by freezing a cooked mushroom ingredient and the mushroom ingredient in method (iii) is a cooked mushroom ingredient.

In some embodiments of the invention method, optionally in combination with any or all the various embodiments disclosed herein, the cooked mushroom ingredient is provided by heating the mushroom ingredient using a heating pan or by boiling water, hot oil, infrared light, magnetic heating, microwave, hot air, or steam.

In some embodiments of the invention method, optionally in combination with any or all the various embodiments disclosed herein, the food article has a meat to mushroom weight ratio ranging from about 1:99 to about 99:1.

In some embodiments of the invention method, optionally in combination with any or all the various embodiments disclosed herein, the food article has a reduced cholesterol level, reduced calories, or a reduced level of glycerides.

In some embodiments of the invention method, optionally in combination with any or all the various embodiments disclosed herein, the food article is a hamburger patty.

In some embodiments of the invention method, optionally in combination with any or all the various embodiments disclosed herein, the meat ingredient is selected from the group consisting of beef, pork, fish, chicken, turkey, lamb, goat, and a combination thereof.

The meat ingredient can be any edible animal meat or fish meat. For example, common edible animal meat or fish meat include, e.g., beef, pork, chicken, turnkey, sheep meat (e.g., lamb), goat meat, tuna, salmon, donkey meat, horse meat, or meat of animal edible in a ethnic culture.

The mushroom ingredient can include any edible mushroom or a mixture of edible mushrooms. Edible mushrooms include wild mushrooms and/or cultivated mushrooms. The mushroom(s) can be uncooked mushroom or cooked mushroom, which are described in more detail below. In some embodiments, the mushroom ingredients include ground fresh mushroom, cooked mushroom, or a mixture thereof. Note, mushrooms have different flavor and nutrients, e.g., soluble fibers, vitamin, and antioxidants. Varying the composition of the mushroom mixture can impart the food article of invention different flavor and nutrients, thereby providing a way to modulate the nutrient content of the food article of invention.

In some embodiments, optionally with one or any combination of features of the various embodiments above, the meat ingredient can be artificial meat.

In some embodiments, optionally with one or any combination of features of the various embodiments above, the meat ingredient specifically excludes artificial meat.

In some embodiments, optionally with one or any combination of features of the various embodiments above, the food article can include other food ingredients, e.g., bean stuff, tofu, flour, flour gluten, oatmeal, dry or fresh vegetable ingredients, potato, tomato, etc.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

As compared to a food article without mushroom, the food article disclosed herein has a lowered or reduced cholesterol level, fat or grease content/level, or calories. The per serving cholesterol content of a food article of invention can be about 90% or below, about 80% or below, about 70% or below, about 60% or below, about 50% or below, about 40% or below, about 30% or below, about 20% or below, or about 10% or below of the per serving cholesterol content of a food article formed from all meat(s) or substantially all meat(s). The per serving grease or fat content of a food article of invention can be about 90% or below, about 80% or below, about 70% or below, about 60% or below, about 50% or below, about 40% or below, about 30% or below, about 20% or below, or about 10% or below of the per serving grease or fat content of a food article formed from all meat(s) or substantially all meat(s). The per serving calories of a food article of invention can be about 90% or below, about 80% or below, about 70% or below, about 60% or below, about 50% or below, about 40% or below, about 30% or below, about 20% or below, or about 10% or below of the per serving calories of a food article formed from all meat(s) or substantially all meat(s).

Additional advantages of the food article disclosed herein is the nutrients from the mushroom ingredient, the nutritional fact per serving of an exemplary mushroom serving is provided below.

### Definitions

Wherever applicable, the definitions to some terms used throughout the description of the present invention as provided below shall apply.

The term “food article” used herein refers to a food article with a pre-set composition, which is preformed and cooked or uncooked. An example of the food article of invention is a patty, available in a grocery store or a fast food store such as McDonald, Burger King, or Wendy's.

The terms “mushroom” and “edible mushroom”, and sometimes “fungus”, are used interchangeably and include any edible mushrooms or a mixture thereof. Such edible mushrooms include wild mushrooms and/or cultivated mushrooms. Wild mushrooms are generally Agaricaceae, Boletaceae, Cantharellaceae, Helvellaceae, Lepiotaceae, Morchellaceae, Lactarius, Russulaceae, Tricholomataceae. Cultivated mushrooms include:
Agaricus bisporus, also known as champignon and the button mushroom. This species also includes the portobello and crimini mushrooms;
Auricularia polytricha or Auricularia auricula-judge (Tree ear fungus), two closely related species of jelly fungi that are commonly used in Chinese cuisine;

Flammulina velutipes, the “winter mushroom”, also known as enokitake in Japan;
Hypsizygus tessulatus (also Hypsizygus marmoreus), called shimeji in Japanese, it is a common variety of mushroom available in most markets in Japan. Known as “Beech mushroom” in Europe.
Lentinus edodes, also known as shiitake, oak mushroom. Lentinus edodes is largely produced in Japan, China and South Korea. Lentinus edodes accounts for 10% of world production of cultivated mushrooms. Common in Japan, China, Australia and North America.
Pleurotus species, the oyster mushroom and king trumpet mushroom. Pleurotus mushrooms are the second most important mushrooms in production in the world, 25% of total world production of cultivated mushrooms. Pleurotus mushrooms are worldwide, China is the major producer. Several species can be grown on carbonaceous matter such as straw or newspaper. In the wild they are usually found growing on wood. Species of Pleurotus include, e.g., Pleurotus cornucopias, Pleurotus eryngii, and Pleurotus ostreatus (Oyster mushroom);
Rhizopus oligosporus—the fungal starter culture used in the production of tempeh. In tempeh the mycelia of R. oligosporus are consumed;
Sparassis crispa—recent developments have led to this being cultivated in California;
Tremella fuciformis (Snow fungus), another type of jelly fungus that is commonly used in Chinese cuisine;
Tuber species, (the truffle), Truffles belong to the ascomycete grouping of fungi. The truffle fruitbodies develop underground in mycorrhizal association with certain trees e.g. oak, poplar, beech, and hazel. These species include Tuber aestivum (Summer or St. Jean truffle), Tuber magnatum (Piemont white truffle), Tuber melanosporum (Perigord truffle), T. melanosporum x T. magnatum (Khanaqa truffle), and Terfezia sp. (Desert truffle);
Ustilago maydis (Corn smut), a fungal pathogen of the maize plants.
Also called the Mexican truffle, although not a true truffle; and
Volvariella volvacea (the “Paddy straw mushroom.”). Volvariella mushrooms account for 16% of total production of cultivated mushrooms in the world.

| Nutrition Facts: Serving Size: 1 cup, pieces or slices (70.0 g) | |
|---|---|
| Amount per Serving | |
| Calories 15 | Calories from Fat 2 |
| | % Daily Value * |
| Total Fat 0.2 g | 0% |
| Saturated Fat 0 g | 0% |
| Monounsaturated Fat 0 g | |
| Polyunsaturated Fat 0.1 g | |
| Cholesterol 0 mg | 0% |
| Sodium 3 mg | 0% |
| Potassium 220 mg | 6% |
| Total Carbohydrate 2.3 g | 1% |
| Dietary Fiber 0.8 g | 3% |
| Sugars 1.3 g | |
| Protein 2.18 g | 4% |
| Vitamin C | 3% |
| Calcium | 2% |
| Iron | 2% |
| Vitamin D | 13.3% |
| Vitamin E | 0.03333333 |
| Thiamin (B1) | 0.063 mg |
| Riboflavin (B2) | 0.287 mg |
| Niacin (B3) | 2.695 mg |
| Vitamin B6 | 3.85% |
| Vitamin B12 | 0.5% |
| Magnesium | 6 mg |
| Panthothenic Acid | 1.05 mg |
| Zinc | 2.4% |
| Manganese | 0.028 mg |

As used herein, the term “frozen” generally refers to the temperature at which a component(s) of the food article of invention (mushroom ingredient or meat ingredient or both) become grindable. Generally, such a temperature is about 0° C. or below, e.g., about −5° C. or below, about −10° C. or below, about −15° C. or below, about −20° C. or below, about −25° C. or below, or about −30° C. or below. The term “freezing” refers to bringing the temperature a component or components of the food article of invention down to a frozen state such that the component or components become grindable.

As used herein, the term “grinding” shall mean an act of bring a component or components of a food article of invention into components of smaller size or diameter. Such an act can be, e.g., grinding, pounding, chopping, blending, or any act of causing a food component to break into its particulate form at a size so as to allow forming a food article disclosed herein. A person of ordinary skill in the art can readily determine the desirable size of the particulate form of the food component in order to form a food article disclosed herein.

As used herein, the term “mixing” can refer to blending individual food components (e.g., a frozen mushroom ingredient and/or frozen meat ingredient) in particulate form (e.g., a ground frozen mushroom ingredient and/or ground frozen meat ingredient) to make a homogeneous or substantially homogeneous mixture of the components. Homogeneous, as used herein, shall mean even or substantially even in terms of distribution of the food components. A person of ordinary skill in the can readily determine what a degree of mixing is sufficient for forming a food article disclosed herein. In some embodiments, mixing can be achieved by grinding a frozen mushroom ingredient and a frozen meat ingredient together to form a homogeneous or substantially homogeneous mixture of the components.

As used herein, the term “cooked” refers to the state of mushroom being heated or otherwise exposed to heat or temperature such that the texture of a “cooked” mushroom becomes soft. An example of causing the mushroom to be “cooked” is to expose the mushroom to a heated medium, such as frying pan or heated oil or boiling water, which a person of ordinary skill in the art can readily recognize. Another example of causing the mushroom to be “cooked” is to expose the mushroom to a radio frequency such as microwave, infrared light (IR) heating, magnetic heating, or heating by hot air or steaming. Conversely, the term “uncooked” refers to a state of mushroom without exposure to heat or a cook method.

As used herein, the term “grease” or “fat” are used interchangeably and refer to glycerides, which are formed by fatty acid and glycerol.

### Antioxidants

An antioxidant is a molecule that inhibits the oxidation of other molecules. Oxidation is a chemical reaction that transfers electrons or hydrogen from a substance to an oxidizing agent. Oxidation reactions can produce free radicals. In turn, these radicals can start chain reactions. When the chain reaction occurs in a cell, it can cause damage or death to the cell. Antioxidants terminate these chain reactions by removing free radical intermediates, and inhibit other oxidation reactions. They do this by being oxidized themselves, so antioxidants are often reducing agents such as thiols, ascorbic acid, or polyphenols.

Although oxidation reactions are crucial for life, they can also be damaging; plants and animals maintain complex systems of multiple types of antioxidants, such as glutathione, vitamin C, vitamin A, and vitamin E as well as enzymes such as catalase, superoxide dismutase and various peroxidases.

In some embodiments, the antioxidant can be in the form an extract such as herbal extract, plant extract, or marine extract.

In some embodiments, antioxidants can be omega-3 fatty acid or an extract containing the same (e.g., fish oil or flaxseed oil), alpha lipoic acid (ALA), conjugated lipoic acid (CLA) or the likes, or combinations thereof.

As used herein, the term antioxidant refers to an exogenous antioxidant and specifically exclude endogenous antioxidant. The term shall be construed to be an external antioxidant added to the food article described herein in addition to any antioxidant that may or may not exist in the food ingredients themselves.

Advantage of the exogenous antioxidant include the health benefits that such exogenous antioxidant can impart to the food article disclosed herein. Additionally, the exogenous antioxidant help preserve the food article so as to prolong the storage life of the food article. Further, the exogenous antioxidant can lower the amount of an preservative that the food article may include. As such, the exogenous antioxidant is an important feature of the present invention.

### Method and System of Making

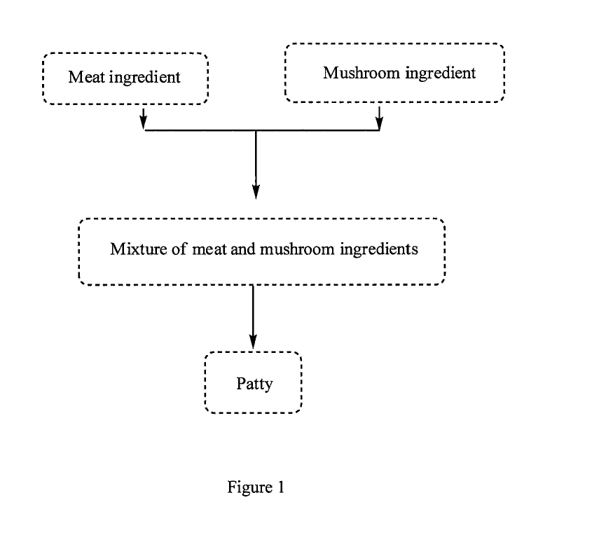

The food article described above can be formed into any acceptable food article, such as hamburger patty, etc., and can be included in a food article in any form, e.g., a hamburger. An embodiment of the present invention is shown in FIG. 1.

A food article disclosed herein can be formed generally by a method comprising the following steps:

providing a frozen mushroom ingredient,

providing a frozen meat ingredient,

grinding the frozen mushroom ingredient to generate a ground mushroom ingredient,

grinding the frozen meat ingredient to generate a ground meat ingredient, and

forming the food article.

In some embodiments, the forming step can include forming a mixture of the ground mushroom ingredient and the ground meat ingredient and pressing the mixture to form the food article.

In some embodiments, a food article disclosed herein can be formed by a method comprising the following steps:

providing a frozen mushroom ingredient,

providing a frozen meat ingredient,

forming a mixture of the frozen mushroom ingredient and the frozen meat ingredient;

grinding the mixture of the frozen mushroom ingredient and the frozen meat ingredient, and

forming the food article.

In some embodiments, a food article disclosed herein can be formed by a method comprising the following steps:

providing a mixture comprising a mushroom ingredient and a meat ingredient,

freezing the mixture comprising a mushroom ingredient and a meat ingredient to generate a frozen mixture comprising a mushroom ingredient and a meat ingredient;

grinding the frozen mixture comprising a mushroom ingredient and a meat ingredient; and

forming the food article.

Various embodiments of the meat ingredient, the mushroom ingredient, and the ratios thereof are all discussed above, which are incorporated in their entirety herein.

In some embodiments, optionally with one or any combination of features of the various embodiments above, the food article can include other food ingredients, e.g., bean stuff, tofu, flour, flour gluten, oatmeal, dry or fresh vegetable ingredients, potato, tomato, etc.

In some embodiments, optionally with one or any combination of features of the various embodiments above, the food article can include seasoning and/or flavoring ingredient(s), e.g., salt, sugar, starch, pepper, onion, scallion, garlic, and other ingredients commonly used in food preparation.

The food article described above can be formed into any acceptable food article, such as hamburger patty, etc., and can be included in a food article in any form, e.g., a hamburger.

The system for making the food article disclosed herein generally includes:

a freezing component(s), for freezing a mushroom ingredient and/or meat ingredient to generate a frozen mushroom ingredient and/or meat ingredient;

a grinding component(s), for grinding the frozen mushroom ingredient and/or meat ingredient to generate a ground frozen mushroom ingredient and/or a ground meat ingredient;

optionally a mixing component, for mixing the ground frozen mushroom ingredient and/or a ground meat ingredient, and any optional nutritional, seasonal, or flavoring ingredients, to generate a mixture comprising mixing the ground frozen mushroom ingredient and/or a ground meat ingredient and optional nutritional, seasonal, or flavoring ingredients; and

a forming component, for forming the food article of invention disclosed above. The forming component can be, for example, a presser or molder

In some embodiments, the system described above can include an optional cooking component, for causing the mushroom to be cooked.

Each of the components described above either are commercially available or can be readily constructed or provided by a person of ordinary skill in the art without undue experimentation. The components described below are provided as examples:

the freezing component can be a freezer or any other device to cause mushroom and/or meat to reach a frozen state, e.g., at a temperature set forth above;

the grinding component can be any of grinder, blender, pounder, etc, which are commercially available or can be provided or constructed readily by a person of ordinary skill in the art;

the mixing component can be a mixer, a grinder, blending, pounder, etc, as long as it is capable of mixing the ingredients of a food article of invention and form a mixture as described above, which are commercially available or can be provided or constructed readily by a person of ordinary skill in the art;

the forming component can be, e.g., a presser or molder, which are commercially available or can be provided or constructed readily by a person of ordinary skill in the art; and

the cooking component generally includes a heating device, which includes a heat generator, a housing having a floor with or without a cover to cook the mushroom with or without a heating medium such as water or oil, optionally a temperature controller to set and control the temperature of cooking the mushroom, and optionally a stirrer, to stir the mushroom to cause it to have an even or substantially even cooking. A cooking component described herein can be, e.g., a container, a tank, an oven, a heating house, a heating belt, a microwave oven, an IR heating house, a magnetic heater plate or oven, for example, which are commercially available or can be provided or constructed readily by a person of ordinary skill in the art. In some embodiments, the cooking component can be a device that provides steam or hot air at a given temperature, which are commercially available or can be provided or constructed readily by a person of ordinary skill in the art.

### EXAMPLES

The following examples illustrate embodiments of a food article described above.

### Example 1

### Mushroom Hamburg Patty

Ingredients: Frozen meats and mushrooms
Method: The general method of invention for forming a patty in the examples are described below:

1. Meat, which can be any type of edible meat(s), is frozen at a temperature from about −3° C. to about −10° C. and ground into small pieces at a temperature from about −3° C. to about −10° C. The small pieces of frozen meat(s) is ground once or twice again to generate the ground frozen meat(s) particles or pieces, which is set aside for use.

2. Edible mushroom(s) is provided and cleansed of/washed away impurities using water. The mushrooms are boiled in boiling water for about 1 to about 3 minutes after washing, and then drained of water and quickly frozen to a temperature from about −3° C. to about −10° C. The frozen mushrooms are ground into frozen mushroom particles/pieces at a temperature from about −3° C. to about −10° C. , which is set aside for use.

3. Mixing or blending the meat and mushroom ingredients obtained in steps 1 and 2 in a selected weight ratio to generate a mixture of the meat and mushroom ingredients.

4. Forming a patty at a given weight using the mixture obtained in step 3.

5. Quickly freezing the patty formed in step 4.

Patties of a ¼ pound having a meat/mushroom weight ratio of 50:50 were formed according to steps 1-5. The patties were cooked and sampled. Sampling of these cooked patties showed satisfactory texture, taste and flavor (data not shown).

### Example 2

### Mushroom Beef Patty Preparation Method

1) The collected mushroom was sorted and cleaned and then quickly frozen to 0° C. and then transferred to the patty plan for use.
2) The frozen mushroom was inspected and cleaned again.
3) The mushroom was placed in boiling water and boiled for 3 minutes for sterilization.
4) Sterilizing: the sterilized mushroom was washed with clean water for three times, and then quickly frozen to 0° C.
5) Grinding: the frozen mushroom was ground to granules of about 1 to 5 mm at a temperature of about −1° C. to 1° C.

The ground mushroom was then packed using a wrapping material such as PE film to avoid direct exposure to oxygen.
6) the ground mushroom was then mixed with ground beef according to a selected ratio, and then quickly packed, and then stored at a temperature between below 0° C. and −18° C.

### Example 3

### Mushroom Beef Patty with an Exogenous Antioxidant

1) The collected mushroom was sorted and cleaned and then quickly frozen to 0° C. and then transferred to the patty plan for use.
2) The frozen mushroom was inspected and cleaned again.
3) The mushroom was placed in boiling water and boiled for 3 minutes for sterilization.
4) Sterilizing: the sterilized mushroom was washed with clean water for three times, and then quickly frozen to 0° C.
5) Grinding: the frozen mushroom was ground to granules of about 1 to 5 mm at a temperature of about −1° C. to 1° C. An antioxidant (food grade vitamin C, 0.1 wt %) was added to the mushroom such that the granules included the antioxidant.

The ground mushroom was then packed using a wrapping material such as PE film to avoid direct exposure to oxygen.
6) the ground mushroom was then mixed with ground beef according to a selected ratio, and then quickly packed, and then stored at a temperature between below 0° C. and −18° C.

While particular embodiments of the present invention have been shown and described, it will be obvious to those skilled in the art that changes and modifications can be made without departing from this invention in its broader aspects. Therefore, the claims are to encompass within their scope all such changes and modifications as fall within the true sprit and scope of this invention.

1. A food article, comprising a homogenous or substantially homogenous mixture of a ground meat ingredient, a ground mushroom ingredient, and an optional exogenous antioxidant,
wherein the ground mushroom ingredient comprises granules of a size from about 1 mm to about 55 mm measured at 0° C. such that, in the homogenous or substantially homogenous mixture, has texture and taste similar to those of the ground meat ingredient.

2. The food article of claim 1, having a meat to mushroom weight ratio ranging from about 1:99 to about 99:1.

3. The food article of claim 1, having a meat to mushroom weight ratio ranging from about 10:90 to about 90:10.

4. The food article of claim 1, having a meat to mushroom weight ratio ranging from about 20:80 to about 80:20.

5. The food article of claim 1, having a meat to mushroom weight ratio ranging from about 30:70 to about 70:30.

6. The food article of claim 1, having a meat to mushroom weight ratio ranging from about 40:60 to about 60:40.

7. The food article of claim 1, having a meat to mushroom weight ratio of about 50:50.

8. The food article of claim 1, wherein the meat ingredient comprises beef, pork, fish, chicken, turkey, lamb, goat, or a mixture of these.

9. The food article of claim 1, which is a patty.

10. The food article of claim 9, which is a hamburger patty.

11. The food article of claim 10, which is cooked or uncooked.

12. The food article of claim 1, having a reduced cholesterol level as compared with a food article comprising a meat ingredient with no mushroom ingredient.

13. The food article of claim 1, having reduced calories per serving of a given weight as compared with a food article comprising a meat ingredient with no mushroom ingredient.

14. The food article of claim 1, comprising the exogenous antioxidant.

15. A method for preparing a food article, comprising:
providing a homogenous or substantially homogenous mixture comprising a ground frozen mushroom ingredient, a ground frozen meat ingredient, and an optional exogenous antioxidant, and
forming the food article,
wherein the ground mushroom ingredient comprises granules of a size from about 1 mm to about 55 mm measured at 0° C. such that, in the homogenous or substantially homogenous mixture, has texture and taste similar to those of the ground meat ingredient, and

16. The method of claim 15, wherein forming the food article comprises pressing the homogenous or substantially homogenous mixture to form the food article.

17. The method of claim 15, wherein the frozen mushroom ingredient in method (i) and method (ii) is provided by freezing a cooked mushroom ingredient and the mushroom ingredient in method (iii) is a cooked mushroom ingredient.

18. The method of claim 17, wherein the cooked mushroom ingredient is provided by heating the mushroom ingredient using a heating pan or by boiling water, hot oil, infrared light, magnetic heating, microwave, hot air, or steam.

19. The method of claim 15, wherein the food article has a meat to mushroom weight ratio ranging from about 1:99 to about 99:1.

20. The method of claim 15, wherein the food article has a reduced cholesterol level, reduced calories, or a reduced level of glycerides.

21. The method of claim 15, wherein the food article is a hamburger patty.

22. The method of claim 15, wherein the meat ingredient is selected from the group consisting of beef, pork, fish, chicken, turkey, lamb, goat, and a combination thereof.

23. The method of claim 15, wherein the mixture comprises the exogenous antioxidant.
